(19) United States
(12) Patent Application Publication
(10) Pub. No.: US 2023/0248206 A1
(43) Pub. Date: Aug. 10, 2023

(54) FLUID DOSING MECHANISMS AND SYSTEMS

(71) Applicant: Rubbermaid Commercial Products LLC, Atlanta, GA (US)

(72) Inventors: Dimple Bhesania, Concord, NC (US); Juan Carlos Perez, Huntersville, NC (US); Jeffrey S. Bertucci, Denver, NC (US); Megan Lee Fritz, Huntersville, NC (US); Brian Wortham Downing, Charlotte, NC (US); Drew A. Berger, Brownsburg, IN (US)

(21) Appl. No.: 18/100,593

(22) Filed: Jan. 24, 2023

Related U.S. Application Data
(60) Provisional application No. 63/306,559, filed on Feb. 4, 2022.
(60) Provisional application No. 63/364,417, filed on May 9, 2022.

(51) Int. Cl. A47L 15/44

(52) U.S. Cl. CPC A47L 15/449

(57) ABSTRACT

A fluid dosing mechanism may include a dosing vessel, a dosing cylinder, a dial, and a piston. The dosing vessel defines a fluid chamber. The fluid chamber includes an inlet and an outlet. The dosing cylinder is coupled to the dosing vessel and defines an end slidable within the fluid chamber. The dial is rotatably coupled to the dosing cylinder and configured to slide the dosing cylinder to define a dosing volume within the fluid chamber against the end of the dosing cylinder. The dosing volume is fluidically coupled to the inlet and the outlet. The piston is movable between (i) a retention position to retain fluid in the dosing volume and (ii) a discharge position to discharge fluid from the dosing volume of the fluid chamber through the outlet. A cart assembly may include a fluid dosing system including a system housing and the fluid dosing mechanism.

### CROSS-REFERENCE TO RELATED APPLICATIONS

This application claims the benefit of U.S. Provisional Application No. 63/306,559, filed Feb. 4, 2022, and claims the benefit of U.S. Provisional Application No. 63/364,417, filed May 9, 2022, both of which are hereby incorporated by reference in their entireties.

### TECHNICAL FIELD

The present disclosure generally relates to fluid dosing mechanisms and systems, and more specifically relates to fluid dosing mechanisms and systems for dispensing predetermined amounts of cleaning or other fluids on cleaning media.

### BACKGROUND

Cleaning media such as pads or wipes may be soaked with one or more solutions, such as cleaning or disinfecting solutions. Some cleaning media may be provided pre-soaked. Other cleaning media may be sold in a dry form, for soaking with an appropriate fluid based on an intended application. For example, a user may need to soak a wipe or a pad in a predetermined amount of solution for effective cleaning or sanitation.

Cleaning carts may be used to store and carry cleaning supplies and tools, including cleaning media and solutions.

A need remains for mechanisms and systems to dispense predetermined amounts of fluid onto a unit of cleaning media, for example, in a cleaning cart.

### SUMMARY

The present disclosure describes fluid dosing mechanisms and systems. For example, the fluid dosing mechanisms and systems may be used to dispense predetermined amounts of cleaning or other fluids on cleaning media.

In aspects, the present disclosure describes a fluid dosing mechanism including a dosing vessel, a dosing cylinder, a dial, and a piston. The dosing vessel defines a fluid chamber. The fluid chamber includes an inlet and an outlet. The dosing cylinder is coupled to the dosing vessel and defines an end slidable within the fluid chamber. The dial is rotatably coupled to the dosing cylinder and configured to slide the dosing cylinder to define a dosing volume within the fluid chamber against the end of the dosing cylinder. The dosing volume is fluidically coupled to the inlet and the outlet. The piston is movable between (i) a retention position to retain fluid in the dosing volume and (ii) a discharge position to discharge fluid from the dosing volume of the fluid chamber through the outlet.

In aspects, the present disclosure describes a fluid dosing system including a system housing including the fluid dosing mechanism. The fluid dosing system further includes a fluid container defining a container outlet fluidically coupled to the inlet of the fluid dosing mechanism.

In aspects, the present disclosure describes a cart assembly including a platform, a tower secured to the platform, a plurality of wheels coupled to the platform, and the fluid dosing system secured to the tower.

### BRIEF DESCRIPTION OF THE DRAWINGS

FIG. 1A is a conceptual exploded view of a fluid dosing mechanism.

FIG. 1B is a conceptual perspective view of the fluid dosing mechanism of FIG. 1A.

FIG. 1C is a conceptual cross-sectional view of the fluid dosing mechanism of FIG. 1A.

FIG. 1D is a conceptual partial side view of the fluid dosing mechanism of FIG. 1A.

FIG. 2A is a conceptual exploded view of a fluid dosing system including the fluid dosing mechanism of FIG. 1A.

FIG. 2B is a conceptual plan view of the fluid dosing system of FIG. 2A.

FIG. 3A is a conceptual exploded view of a cart assembly including the fluid dosing system of FIG. 2A.

FIG. 3B is a conceptual partial exploded view of the cart assembly of FIG. 3A.

FIG. 4 is a conceptual perspective view of the fluid dosing system of FIG. 3A.

FIG. 5 is another conceptual perspective view of the fluid dosing system of FIG. 3A.

FIG. 6 is a conceptual view of the of the fluid dosing system of FIG. 3A.

FIG. 7 is a conceptual partial cross-sectional view of the fluid dosing system of FIG. 3A.

FIG. 8 is another conceptual partial cross-sectional view of the fluid dosing system of FIG. 3A.

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar, but not necessarily the same or identical components. Different reference numerals may be used to identify similar components. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION

The present disclosure includes non-limiting embodiments of fluid dosing mechanisms and systems. The embodiments are described in detail herein to enable one of ordinary skill in the art to practice the fluid dosing mechanism, system and associated methods of making, although it is to be understood that other embodiments may be utilized and that logical changes may be made without departing from the scope of the disclosure. Throughout the disclosure, depending on the context, singular and plural terminology may be used interchangeably.

A supply of cleaning media such as wipes or pads may be provided in a dry form, for example, for improved shelf life. A unit of such cleaning media may be wetted or soaked with a fluid, shortly before use. For example, a user may wet or soak a wipe or pad with cleaning fluid. The cleaning fluid may be formulated to provide effective cleaning or sanitation when adequately soaked. For example, a manufacturer of a cleaning fluid may recommend soaking a particular unit of cleaning media with a predetermined amount (for example, 10 mL, 25 mL, 50 mL, or more) of the cleaning fluid. Different types of cleaning fluids (for example, for cleaning different types of substrates such as tile, ceramic, wood, vinyl, stone, and so on, or for different applications such as sanitizing to reduce microbial activity) may need to be dispensed in different amounts. The cleaning media and fluid may be stored and transported on a cart.

The present disclosure describes fluid dosing mechanisms and systems. For example, the fluid dosing mechanisms and systems may be used to dispense predetermined amounts of cleaning or other fluids on cleaning media. Such fluid dosing mechanisms and systems may provide convenience by allowing a user to dispense or discharge a predetermined (for example, preset by the user) amount of fluid without needing to measure the fluid.

In aspects, the present disclosure describes a fluid dosing mechanism including a dosing vessel, a dosing cylinder, a dial, and a piston. The dosing vessel defines a fluid chamber. The fluid chamber includes an inlet and an outlet. The dosing cylinder is coupled to the dosing vessel and defines an end slidable within the fluid chamber. The dial is rotatably coupled to the dosing cylinder and configured to slide the dosing cylinder to define a dosing volume within the fluid chamber against the end of the dosing cylinder. The dosing volume is fluidically coupled to the inlet and the outlet. The piston is movable between (i) a retention position to retain fluid in the dosing volume and (ii) a discharge position to discharge fluid from the dosing volume of the fluid chamber through the outlet.

Thus, a user may turn the dial to set a predetermined dosing volume (for example, in increments of 10 mL, 20 mL, 25 mL, 30 mL, or any other suitable increments). Once the dial is set, the user can sequentially dispense the set amount of dosing volume of a cleaning fluid from the fluid chamber onto a unit of a cleaning media, such as a wipe or a pad. The cleaning media may include woven or nonwoven fabric, foam, padding, batting, or any other form of a natural or artificial material, such as cellulose, or any polymer, or combinations thereof. The fluid dosing mechanism may be replenished by a supply of fluid from a container coupled to the fluid dispensing mechanism. When the unit of cleaning media is used and needs to be replaced, the user may discard the used unit and take a fresh unit, and simply engage the piston to dispense the set volume of cleaning solution.

In aspects, the present disclosure describes a fluid dosing system including a system housing including the fluid dosing mechanism. The fluid dosing system further includes a fluid container defining a container outlet fluidically coupled to the inlet of the fluid dosing mechanism.

In aspects, the fluid dosing system may include multiple containers holding different cleaning fluids, and cleaning media may be dosed with set amounts or volumes of one or more cleaning fluids (for example, different fluids in different cleaning and sanitization environments or substrates, or even combinations of fluids).

In aspects, the present disclosure describes a cart assembly including a platform, a tower secured to the platform, a plurality of wheels coupled to the platform, and the fluid dosing system secured to the tower. The cart assembly may be used to carry a supply a fresh cleaning media and/or store used media, and a button or another component of the cart assembly may be engaged with the piston, while the cart assembly may be configured to direct fluid discharged by the fluid dosing system toward a unit of cleaning media. In this way, a user can conveniently and quickly wet or soak a series of units of cleaning media with set amounts or volumes of cleaning fluid as needed during a cleaning session.

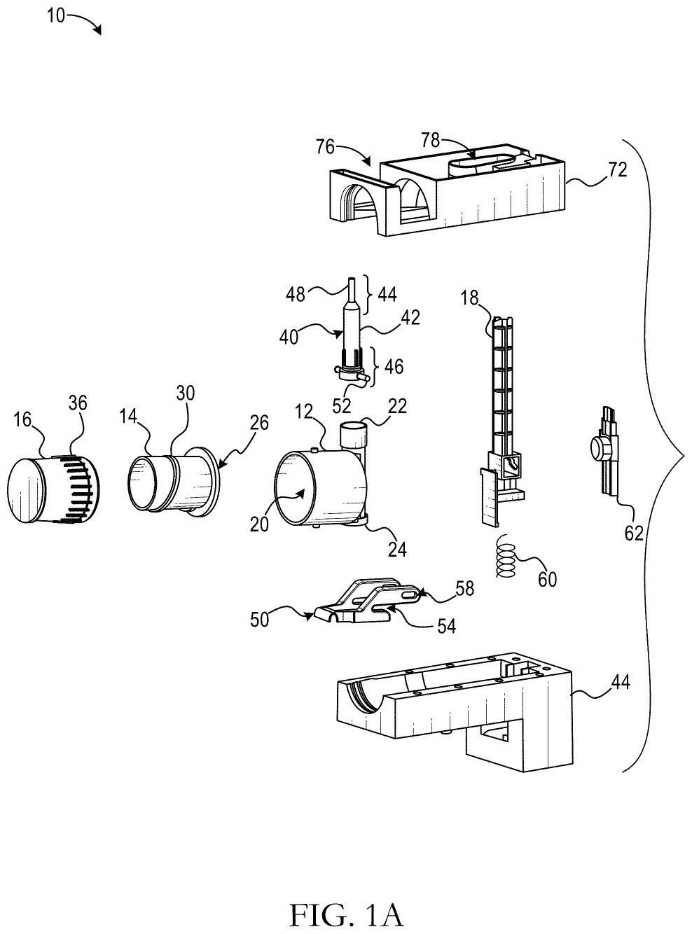

FIG. 1A is a conceptual exploded view of a fluid dosing mechanism 10. FIG. 1B is a conceptual perspective view of the fluid dosing mechanism 10 of FIG. 1A. FIG. 1C is a conceptual cross-sectional view of the fluid dosing mechanism 10 of FIG. 1A. FIG. 1D is a conceptual partial side view of the fluid dosing mechanism 10 of FIG. 1A.

The fluid dosing mechanism 10 includes a dosing vessel 12, a dosing cylinder 14, a dial 16, and a piston 18. The dosing vessel 12 defines a fluid chamber 20. The fluid chamber 20 includes an inlet 22 and an outlet 24. In aspects, the outlet 24 is lower than the inlet 22 relative to a direction of gravity, so that gravity induces flow of fluid into the fluid chamber 20 through the inlet 22, and flow of fluid out from the fluid chamber 20 through the outlet 24.

The dosing cylinder 14 is coupled to the dosing vessel 12 and defines an end 26 slidable within the fluid chamber 20. The dial 16 is rotatably coupled to the dosing cylinder 14 and configured to slide the dosing cylinder 14 to define a dosing volume 28 within the fluid chamber 20 against the end 26 of the dosing cylinder 14. The dosing volume 28 is fluidically coupled to the inlet 22 and the outlet 24. The dosing volume 28 may be adjusted by the user by turning the dial 16, which causes the dosing cylinder 14 to move within the fluid chamber 20, ultimately changing the dosing volume defined against the end 26 of the dosing cylinder. To reduce or avoid leakage past the end 26, a seal 27 may be provided about a rim or peripheral surface of the dosing cylinder 14, as shown in FIG. 1C. The seal 27 may be in the form of a gasket or o-ring.

The piston 18 is movable between (i) a retention position (the position marked by reference numeral 18 in FIGS. 1B, 1C, and 1D) to retain fluid in the dosing volume and (ii) a discharge position to discharge fluid from the dosing volume of the fluid chamber through the outlet (the dashed position marked by reference numeral 18a in FIG. 1C).

The inlet 22 of the fluid dosing mechanism 10 may be fluidically coupled to a supply of cleaning fluid. For example, the inlet 22 of the fluid dosing mechanism 10 may receive a portion or volume of fluid from the fluid supply in the retention position, and that portion or volume of fluid may occupy substantially an entirety of the dosing volume 28. When the piston 18 is moved to the discharge position 18a, the contents of the dosing volume 28 are discharged through the outlet 24. The outlet 24 may be coupled to a nozzle, a tube, or some other mechanism to ultimately direct the discharged fluid toward a unit of cleaning media. In this way, the predetermined amount or set volume (of the dosing volume 28) of fluid may be wetted or soaked onto cleaning media. When the piston 18 is returned or moved back to the retention position, the dosing volume 28 receives a fresh supply of the fluid through the inlet 22

In aspects, one of the dosing cylinder 14 and the dial 16 defines a helical channel 30. In such aspects, the other of the dosing cylinder 14 and the dial 16 defines a pin 32 engaged in the helical channel 30, to convert relative rotation between the dosing cylinder 14 and the dial 16 to a translation of the dosing cylinder 14. For example, as shown in FIG. 1C, the dosing cylinder 14 may define the helical channel 30, and the dial 16 may define the pin 32. However, the opposite configuration may be used. Further, while the helical channel 30 and the pin 32 may be defined by the dosing cylinder 14 or the dial 16 (for example, extending integrally from or in a unitary manner from those components), in other aspects, one or both of the helical channel 30 or the pin 32 may be separate components secured, coupled, welded, or adhered to the underlying components.

In aspects, the dial 16 defines a dial interior 34 configured to receive at least a portion of the dosing cylinder 14. The helical channel 30 and the pin 32 may be within the dial interior 34.

In aspects, the dial 16 defines a plurality of exterior dial ribs 36, wherein the dial ribs 34 are equally spaced about the dial. Each rib of the plurality of ribs 36 represents a respective location of the end 26 of dosing cylinder 14 within the fluid chamber 20 corresponding to a respective magnitude of the dosing volume 28 within the fluid chamber 20. Thus, the user may count the number of ribs moved past a mark to determine the increments (or decrements) to the magnitude of the dosing volume 28. In some such aspects, each rib of the plurality of ribs corresponds to a change of 25 mL of the dosing volume.

In some such aspects, in addition to, or instead of, the ribs, the dial 16 may be provided with a plurality of volumetric indicia denoting the magnitude of the dosing volume 28. For example, the plurality of volumetric indicia may include a sequence of numbers (25, 50, 75, 100, and so on) denoting the magnitude (in mL or some other volumetric unit) of the dosing volume 28. In this way, the user can quickly turn the dial to set a predetermined magnitude of the dosing volume 28.

In aspects, a maximum spacing of the end 26 of the dosing cylinder 14 within the fluid chamber 20 defines a maximum dosage volume 28. For example, a maximum outward travel of the dosing cylinder 14 relative to the dosing vessel 12 may define the maximum dosage volume. In some aspects, the maximum dosage volume is 300 mL. The dosing vessel may be provided with a flange, rib, channel, detent, or some other feature to restrict, resist, or prevent outward travel of the dosing cylinder 14 beyond the maximum dosage volume 28, and to reduce, resist, or prevent leakage of the contents of the dosing volume 28.

In aspects, the fluid dosing mechanism 10 further includes a valve 40. The piston 18 may be mechanically coupled to the valve 40 to cause the valve 40 to move between (i) a first configuration that opens the inlet 22 and closes the outlet 24 to retain fluid in the dosing volume 28, and (ii) a second configuration that closes the inlet 22 and opens the outlet 24 to discharge fluid from the dosing volume. For example, the movement of the valve 40 may be in direction transverse to the direction of travel of the dosing cylinder 14 relative to the dosing vessel 12.

In aspects, the valve 40 includes a valve body 42 extending between an inlet portion 42 and an outlet portion 46. The inlet portion 42 is spaced from the inlet 22 and the outlet portion 44 is sealingly engaged with the outlet 24 in the first configuration. Vice versa, the inlet portion 42 is sealingly engaged with the inlet 22 and the outlet portion 24 is spaced from the outlet 24 in the second configuration. In this way, fluid is retained in the dosing volume 28 in the first configuration, and no fluid is replenished into the dosing volume 28 from the inlet 22 during the discharge.

In some aspects, one or both of the outlet portion 44 and the inlet portion 42 define a respective conic surface, and the valve body includes a cylindrical portion (i) extending from the respective conic surface, or (ii) between respective conic surfaces of the outlet portion 44 and the inlet portion 42.

In some aspects, the valve 40 further includes an outlet seal 46 at the outlet portion 44. In some aspects, the valve further comprises an inlet seal at the inlet portion. One or both of the outlet seal 46 or the inlet seal may include a respective o-ring.

In aspects, the inlet portion 42 of the valve 40 further defines a stem 48 extending through the inlet 22. The stem 48 is configured to engage with a fluid container in the first configuration to receive fluid from the fluid container into the dosing volume through the inlet 22, and to disengage from the fluid container in the second configuration. In this way, the fluid container may avoid dispensing solution in the second configuration, which may reduce, resist, or prevent leaks. As seen in FIG. 1B, the stem 48 may define a plus-shaped cross-section. Such a cross-section may provide strength and reduce or avoid flexing or bending of the stem 48.

In aspects, the fluid dosing mechanism 10 may further include a base 50 pivotably coupled between the piston 18 and the valve 40. For example, the piston 18 may pivot the base 50 to cause the valve 40 to move between the first configuration and the second configuration.

In some aspects, the outlet portion 46 of the valve further defines at least one valve pin 52, and the base 50 defines at least one valve channel 54 configured to slidingly receive the at least one valve pin 52. In some aspects, the piston 18 further defines at least one piston pin 56, and the base 50 defines at least one piston channel 58 configured to slidingly receive the at least one piston pin 56. The engagement of the pins 52 and 56 with the channels 54 and 58 may assist in limiting a motion of the piston 18 and/or the valve 40 in respective predetermined ranges of travel, and may facilitate smooth movement of the components.

To facilitate the return of the piston 18 to the first configuration from the second configuration (or vice versa) the fluid dosing mechanism 10 may further include a biasing member 60 coupled to the piston 18. The biasing member 60 may be biased to move the piston 18 from the discharge position 18a to the retention position. For example, the biasing member 60 may get progressively compressed as the piston 18 moves to the discharge position 18a, such that the biasing member 60 may tend to push back the piston 18 to the retention position. In some such aspects, the biasing member includes a spring. For example, the spring may be compressed when the piston 18 is in the discharge position. However, another configuration may be used where the spring is expanded when the piston 18 is in the discharge position 18a, and the spring tends to pull back the piston 18 to the retention position.

To maintain the piston 18 in the discharge position 18a (or otherwise maintain the piston 18 away from the retention position) for a sufficient period of time to allow substantially complete discharge of fluid from the dosing volume 28, the fluid dosing mechanism 10 may further include a damper 62 coupled to the piston 18. The damper 62 may be configured to resist movement of the piston 18 toward the retention position (for example, from the discharge position 18a). The damper may be a mechanical damper, gas-filled or pressurized damper, or include a damping member such as a spring. For example, the spring in the damper may function in a manner opposite to that of the biasing member 60, such that the damper 62 effectively resists or slows down movement of the piston 18 driven by the biasing member 60. In aspects, the damper 62 is configured to resist movement of piston 18 the toward the retention position for a predetermined period of time to substantially discharge an entirety of the contents of the dosing volume from the outlet 24.

The components of the fluid dosing mechanism 10 may be protected from the environment or from other components. For example, the fluid dosing mechanism 10 may further include a housing 70 securing at least one of the dosing vessel 12, the dosing cylinder 14, the dial 16, and the piston 18. In some such aspects, the housing 70 includes a top casing 72 and a bottom casing 74. The top casing may be secured to the bottom casing 74 by welding, adhesives, or fasteners, for example, screws or pins. The housing 70 may define a dial window 76, so that at least a portion of the dial 16 is accessible through the dial window 76. The housing 70 may define a piston window 78, so that at least a portion of the piston 18 protrudes through the piston window 78. In this way, a user can engage the piston and the dial through an exterior of the housing 70. The housing may further define a stem window 80, so that at least a portion of the stem 48 of the valve 40 protrudes through the stem window 80. In this way, the stem 48 may communicate mechanically with a fluid container through an exterior of the housing 70. While different windows 76, 78, and 80 may be present, it is understood that one or more of these windows may be combined or stacked.

In aspects, the housing 70 defines a housing outlet fluidically coupled to the outlet 24 of the fluid chamber 20, and a housing inlet coupled to the inlet 22 of the fluid chamber 20. The housing inlet may coincide or pass through stem window 80. The housing outlet may pass through a bottom of the housing, for example, adjacent the outlet 24.

Any component of the fluid dosing mechanism 10 may be formed of any suitable material, for example, a plastic, a metal, or an alloy, or combinations thereof. The components may be formed by molding, thermoforming, stamping, casting, machining, additive manufacturing, or any suitable process.

Thus, the fluid dosing mechanism 10 may be used to discharge a predetermined or set volume of fluid toward or on a unit of cleaning media.

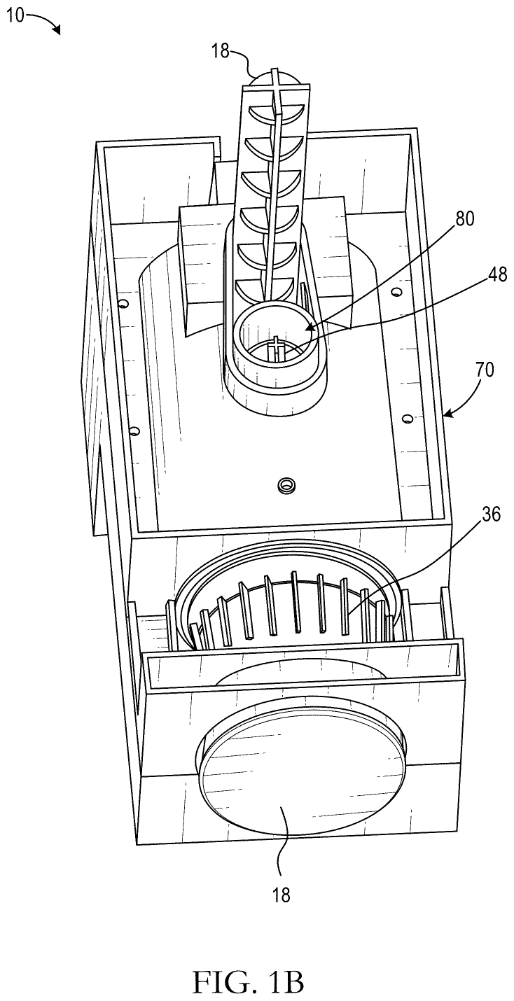

FIG. 2A is a conceptual exploded view of a fluid dosing system 100 including the fluid dosing mechanism 10 of FIG. 1A. The fluid dosing system 100 dispenses selected amount of chemical solution to a charge pad, cloth, or wipe. The fluid dosing system 100 may also store clean and dirty pads. The fluid dosing system 100 may have the ability to carry and dispense two different chemicals (and/or any other number of different chemicals) that are securely stored within the system. The fluid dosing system 100 may be attaches to a cart to allow mobility. The system can be customized to dispense amounts from 25 ml to 300 ml in 25 ml increments. Other incremental amounts may be used in different embodiments, as well as configurable amounts, such as adjusting from 5 ml to 50 ml or any increment in between, etc.

The present disclosure includes non-limiting embodiments of a fluid dosing system and methods for manufacturing the same. The embodiments are described in detail herein to enable one of ordinary skill in the art to practice the fluid dosing system and associated methods of making, although it is to be understood that other embodiments may be utilized and that logical changes may be made without departing from the scope of the disclosure. Throughout the disclosure, depending on the context, singular and plural terminology may be used interchangeably.

The fluid dosing system 100 includes a system housing 102 (shown in FIG. 2B) including the fluid dosing mechanism 10. The fluid dosing system 100 further includes a fluid container 104 defining a container outlet 106 fluidically coupled to the inlet 22 of the fluid dosing mechanism 10. The fluid container 104 may further include a container inlet 108 to receive a supply of fluid within the fluid container 104. The fluid container 104 may include any suitable cleaning or maintenance solution.

While a single fluid container 104 is shown in FIG. 2A, more than one fluid container may be present. In some aspects, the fluid container 104 is a first fluid container, and the fluid dosing system further includes a second fluid container defining a respective container outlet fluidically coupled to the inlet 22 of the fluid dosing mechanism. When multiple fluid containers are present, the fluids may be combined into inlet 22, or may be separately selected and routed, for example, by a toggle, to the inlet 22. In some aspects, the fluid dosing system further includes a fluid junction 119 including a first junction inlet 112, a second junction inlet 114, and a junction outlet 116. The first junction inlet 112 may be fluidically coupled to the container outlet of the first fluid container, the second junction inlet 114 may be fluidically coupled to the container outlet of the second fluid container, and the junction outlet 116 may be fluidically coupled to the inlet 22 of the fluid dosing mechanism 10. The fluidic coupling may be through pipes, tubing, conduits, or any other suitable channel. In some aspects, the fluid junction 110 further includes a fluid switch 118 configured to permit flow from only one of the first fluid container and the second fluid container to the junction outlet 116. The switch 118 may include a toggle coupled to a sealing element that seals from one or more inlets, to allow fluid from only one container to pass through the junction outlet.

The piston 18 may be indirectly engaged by the user through the fluid dosing system 100. For example, the system housing 102 may further include a button 121 (shown in FIG. 2B) coupled to the piston 18. Pressing the button 121 may cause the piston 18 to move from the retention configuration to the discharge configuration 18a. The piston 18 may eventually move back to the retention configuration (for example, through the biasing member 60) to cause the button to resume a ready configuration.

The dial 16 may be engaged by the user through the fluid dosing system 100. For example, the system housing 102 may define an access window 123 (also shown in FIG. 2B), and the dial 16 of the fluid dosing mechanism 10 may be accessible through the access window.

In aspects, the system housing 102 further includes a container tray 124 configured to hold at least one fluid container, which may include the fluid container 104. In some aspects, the container tray 124 defines at least one viewing slot 126 configured to show a fluid level in the at least one container. In some aspects, the system housing 102 includes a front panel 130. The front panel 130 may be coupled to the container tray 124. The front panel 130 may define at least one panel slot 132 (for example, panel slots 132A, 132B shown in FIG. 2B) aligned with the at least one viewing slot 126. Thus, a user may conveniently view a level of fluid in the fluid container 104 through an exterior of the system housing 102.

In one embodiment, the container tray 124 is coupled to the left side panel 138, right side panel 136, lid 134, rear panel 140, and front panel 130 The container tray 124 may further couple to a dosing mechanism 10 that connects the containers 104 to outside of the container tray 124. In some embodiments, the container tray 124 may comprise handles on the outside for easy gripping of the fluid dosing system 100. In some embodiments, the container tray 124 has a first container 134 and a second container. In one embodiment, the container tray 124 may be fully enclosed by the left side panel 138, right side panel 136, and rear panel 140. In another embodiment, the container tray 124 may have a lip or edge extending between the left side panel 138, right side panel 136, rear panel 140, and lid 134.

In some embodiments, a front plate 130 is attached to the container tray 124. The front plate 130 may have an panel slot 132A, 132B aligned with slits in the container such that a user can see through the panel slots 132A, 132B and determine the level of solution in the container 104. The front plate 130 may also mechanically couple to the lid 134. The lid 134 is secured to the front plate 130 via a lock 190. The front plate 130 may use a key fob to unlock the lid 134. Opening the lid 134 from the front plate 130 allows access to the container tray 124 and containers 104 for replacement and maintenance. The lock 190 may be any suitable lock for securing the lid in this manner.

FIG. 2B is a conceptual plan view of the fluid dosing system 100 of FIG. 2A. In aspects, the system housing 102 includes a lid 134, a right side panel 136, a left side panel 138, a back panel 140, and a bottom panel 142 that partially make up the walls of the system 100. The side panels 136, 138, bottom panel 142, back panel 140, and front panel 130 may fasten together using screws (or may be fastened together using any other mechanism). The panels may be removable for maintenance or cleaning.

In aspects, the fluid dosing system 100 further includes a cleaning media tray 117 coupled to the system housing 102. The outlet 24 of the fluid dosing mechanism 10 may be configured to discharge fluid toward the cleaning media tray 117. For example, a wipe or pad may be placed on the cleaning media tray 117, to receive the predetermined volume of fluid. After the wipe or pad is wetted or soaked by the fluid, the user may proceed to use the wipe or pad for cleaning, and replace the used wipe or pad with a fresh unit.

In aspects, the fluid dosing system 100 further includes a clean pad drawer 127 secured to the system housing configured to hold a supply of fresh cleaning media. The clean pad drawer 127 may attach to the rear panel 140, left side panel 138, right side panel 136, or any combination thereof. Clean pads, wipes, clothes, or other materials may be stored within the container. In one embodiment, the clean pad drawer 127 may be attached to the side panels 136, 138 by rails to slide away from the rear panel 140 for opening. In another embodiment, the clean pad drawer 127 may open/close by tilting the container 104 using side pivots of side panels 136, 138.

In some aspects, the fluid dosing system 100 further includes a used pad drawer 128 secured to the system housing configured to hold used cleaning media. In some such aspects, the cleaning media tray 117 may be secured to or placed on a top of the used pad drawer 128, for example, as a lid. The used pad drawer 128 may be secured to the left side panel 138 and right side panel 136 via rails, allowing the used pad drawer 128 to slide in and out from the back panel 140. The used pad drawer 128 may be any shape to hold dirty pads, wipes, or cloths and prevent drainage of the excess solution from the pads, wipes, and cloths.

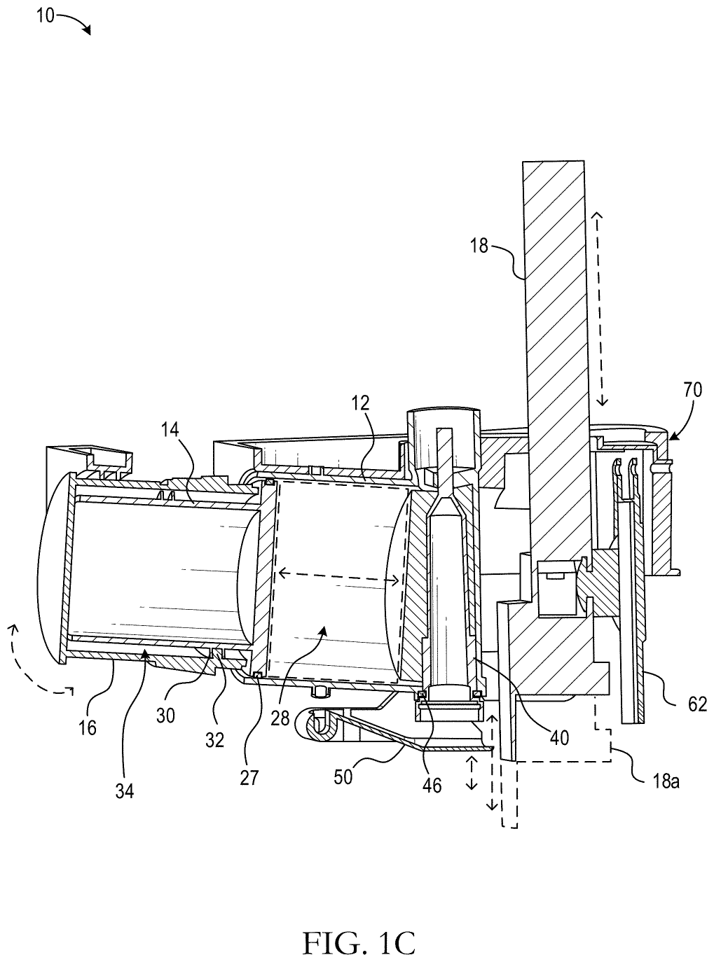

The fluid dosing system 100 may be stored and transported by the user, for example, in a cart. FIG. 3A is a conceptual exploded view of a cart assembly 180 including the fluid dosing system 100 of FIG. 2A. FIG. 3B is a conceptual partial exploded view of the cart assembly 180 of FIG. 3A. The cart assembly 180 may include a platform 184, a tower 182 secured to the platform 184, a plurality of wheels 188 coupled to the platform 184, and the fluid dosing system 100 secured to the tower 182. The fluid dosing system 100 may be removably secured to the tower 182, for example by engagement of first row of protrusions 105A, 105B, second row of protrusions 107A, 107B, third row of protrusions 109A, 109B, and/or any other protrusions of the fluid dosing system in respective slots 186 of the tower. In one embodiment, the back panel 140 of the fluid dosing system 100 may have the first row of protrusions 105A, 105B, second row of protrusions 107A, 107B, and third row of protrusions 109A, 109B. In another embodiment, the first row of protrusions 105A, 105B may be disposed on the rear side of the container tray 124 instead. The protrusions may also be disposed in any other manner on either the fluid dosing system 100 or the tower 182.

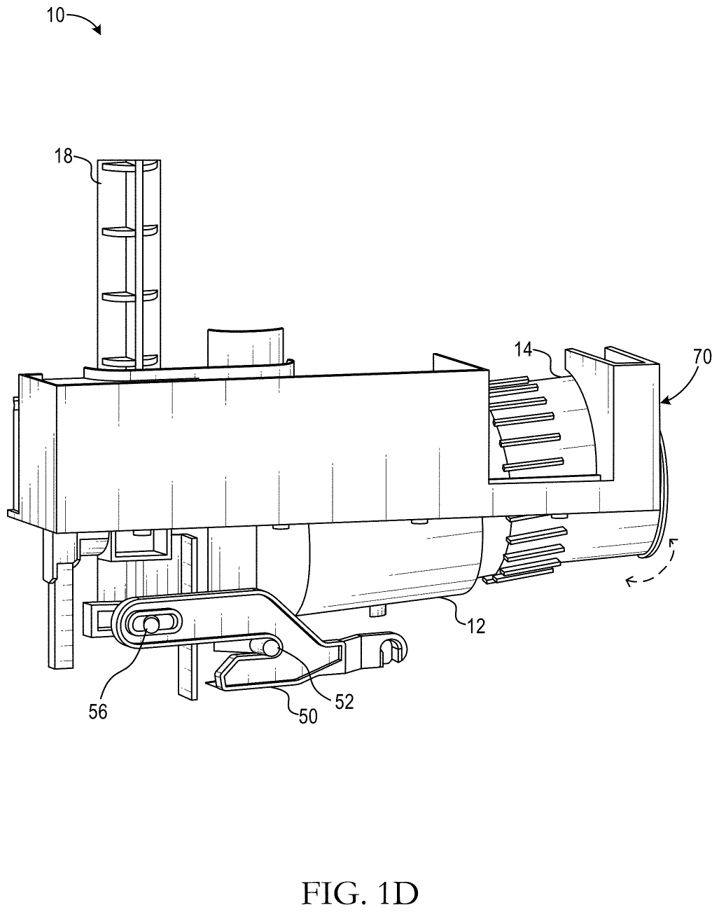

In some embodiments, the dosing mechanism 10 is coupled to the container tray 124. The dosing mechanism 10, as shown in the exploded view of FIG. 2A, is inserted such that the buttons extend above the container tray 124 and through apertures in the lid 134. Another embodiment of the dosing mechanism is shown in FIG. 4 as dosing mechanism 200 (which may have similar or different elements as any other dosing mechanism described herein). As shown in FIG. 4, the dosing mechanism 200 has a clamshell 204 at least partially surrounding the rest of the dosing mechanism 200. The bottom of the clamshell has inlets 214A, 214B and outlets 218A, 218B, that are connected to tubing by hose clamps 216A, 216B. The dosing mechanism 200 is configured such that pressing the button 202A dispenses a predetermined amount of solution from a container connected by the inlet 214A through the outlet 218A toward the tray 117. The dosing mechanism 200 is configured such that pressing the button 202B dispenses a predetermined amount of solution from a container connected by the inlet 214B through the outlet 218B toward the tray 117. The dosing mechanism 200 has holes 220A, 220B configured to allow pins to be inserted to control how far the button 202A, 202B can be depressed. The holes 220A, 220B extend through the container tray 124 and front panel 130 to allow configuration of the amount of solution dispensed.

In some embodiments, the dosing mechanism 200, as shown in FIG. 4, has buttons 202A, 202B (which may also be the same as button 212, in some cases) extending outside the clamshell 204. The buttons 202A, 202B extend out of the clamshell 204, above the container tray 124, and through apertures in the lid 134 such that the buttons 202A, 202B may be pressed when the lid is closed. The dosing mechanism 200 buttons 202A, 202B each connect to a plunger 210A, 210B.

In some embodiments, the plunger 210A, 210B extends from the button 202A, 202B, through a plunger cylinder 208A, 208B, through a spring 212A, 212B, and into a cylinder 222A, 222B. The plunger 210A, 210B may have a cross-shaped shaft and a circular head to fit the cylinder 222A, 222B.

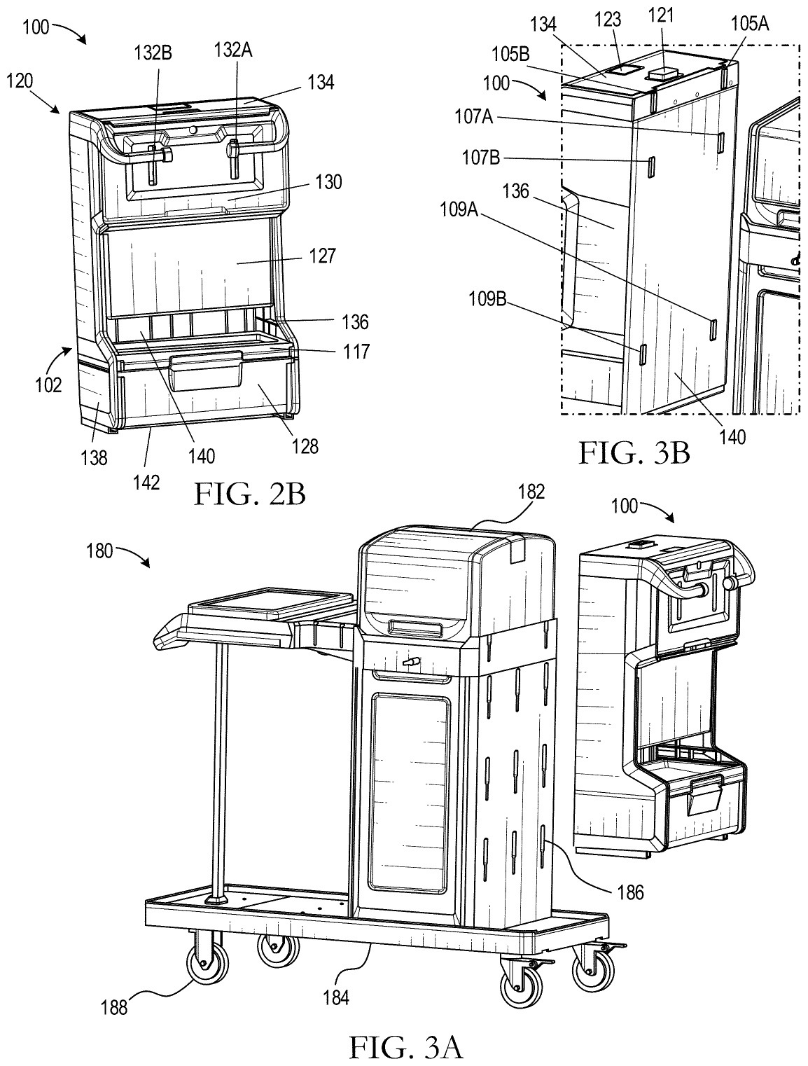

In some embodiments, a locking mechanism 206 extends partially outside the clamshell 204. The locking mechanism, as shown in FIG. 6, has a wing 602A, 602B that is configured to interact with a plunger cylinder 208A, 208B to prevent movement of button 202A, 202B. The locking mechanism 206 may slide between locking one button 202A, or the other button 202B.

In some embodiments, a plunger cylinder 208A, 208B is disposed around the plunger 210A, 210B and inside the clamshell. The plunger cylinder 208A, 208B has a collar to mechanically couple with a locking mechanism 206. The plunger cylinder 208A, 208B contacts a pin extending through a hole 220A, 220B in the clamshell to control how much solution is dispensed when the button is pressed.

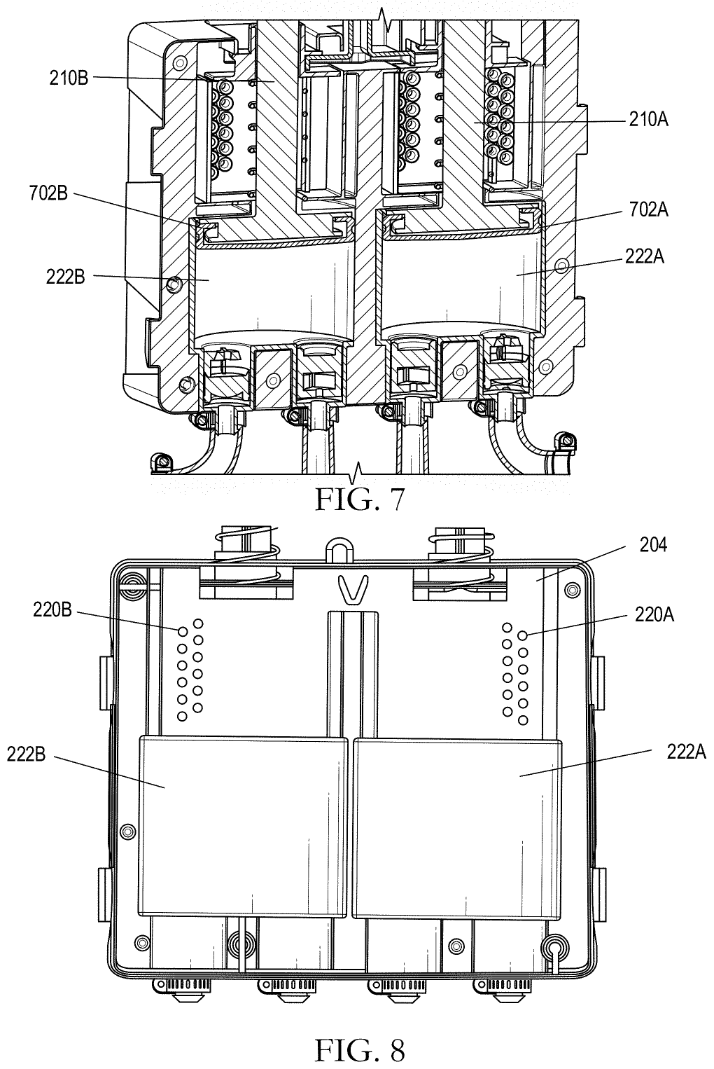

In some embodiments, holes 220A, 220B extend through the clamshell 204. The holes 220A, 220B are configured to receive pins that will prevent the plunger cylinder 208A, 208B from being depressed past a certain point. In one embodiment, as shown in FIG. 8, the top most hole allows for 25 ml of solution to be dispensed per button press, and the bottom hole allows for 300 ml of solution to be dispensed per button press. Together, the holes 220 and pins (not shown) comprise a selection mechanism.

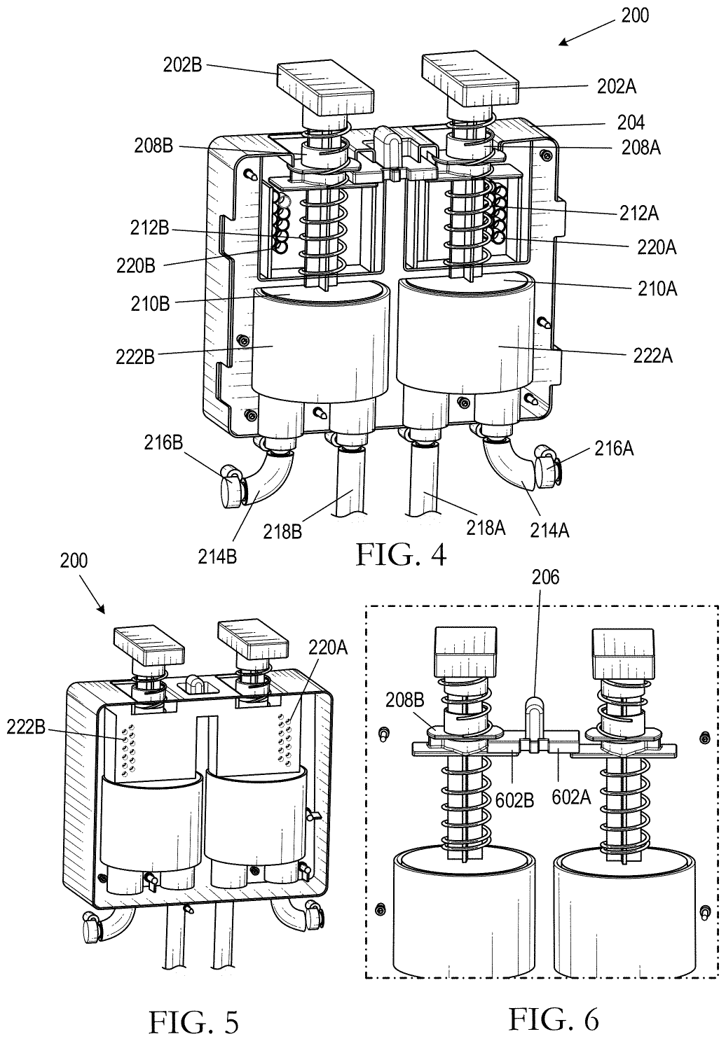

In some embodiments, the cylinder 222A, 222B is air tight, such that a pressure is created when the plunger 210A, 210B rises to pull solution from the container 134. The cylinder 222A, 222B then pushes out solution as the plunger 210A, 210B is depressed through the cylinder. The cylinder 222A, 222B, as shown in FIG. 7, contains a gasket 702A, 702B that keeps the cylinder sealed against the plunger 210A, 210B.

In some embodiment, upon pressing the button 202A, 202B, the plunger 210A, 210B slides inside a cylinder 222A, 222B as spring 212A, 212B compresses, a check valve opens and dispenses a solution in the tray 117. The plunger 210A, 210B travel distance above a pin (not shown) from original position, where the pin acts as stopper as the plunger 210A, 210B travels downward and plunger cylinder 208A, 208B hits pin in order to dispense selected dosage. Once the solution gets dispensed, user lets go of the button 202A, 202B and plunger 210A, 210B travel back to original position as the spring 212A, 212B expands.

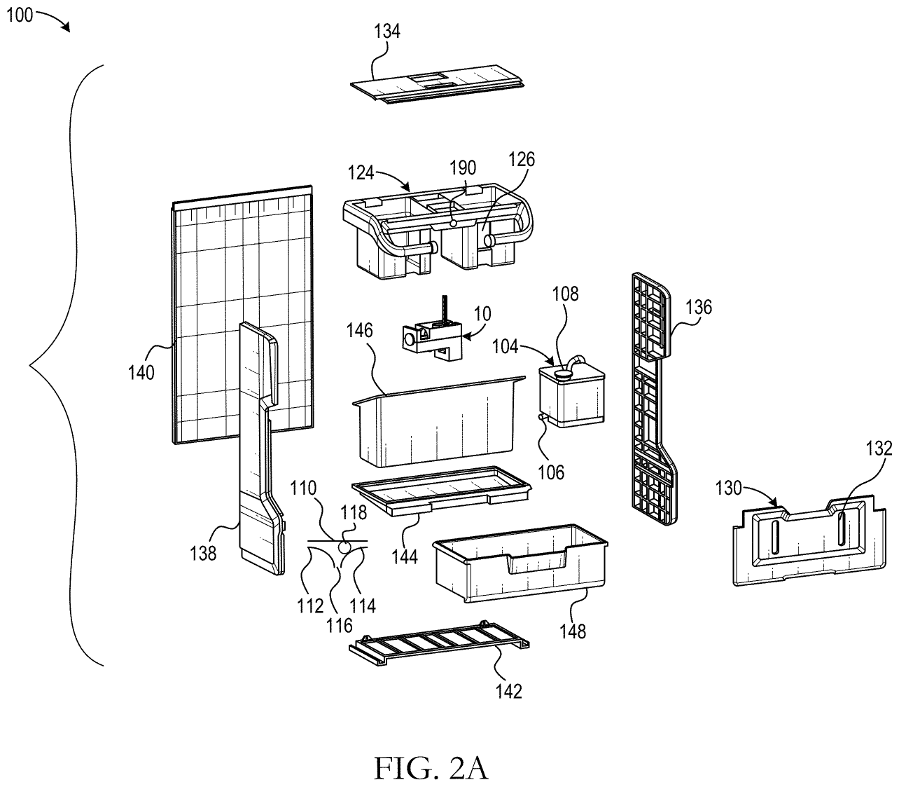

In some embodiments, when a container 104 is placed in its placed inside the container tray 124, it has valve that opens up with small piston engaging to it that is located in the inlet tubing (that connects the container 104 and dosing mechanism 200), allowing a solution to pass through tubing. An inlet check valve located at the end of the dosing mechanism 200 opens up due to pressure of incoming liquid and allows liquid to collect in the cylinder 222A, 222B which is ready to dispense as soon as one presses the button 202A, 202B. Any of the elements of the dosing mechanism 200 shown in FIGS. 4-9 may be the same as the elements shown in FIG. 1A (and/or any other figure).

While the present disclosure has been described with reference to a number of embodiments, it will be understood by those skilled in the art that the invention is not limited to such disclosed embodiments. Rather, the invention can be modified to incorporate any number of variations, alterations, substitutions, or equivalent arrangements not described herein, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

### Example Embodiments

Embodiment 1. fluid dosing mechanism comprising: a dosing vessel defining a fluid chamber, the fluid chamber comprising an inlet and an outlet; a dosing cylinder coupled to the dosing vessel and defining an end slidable within the fluid chamber; a dial rotatably coupled to the dosing cylinder and configured to slide the dosing cylinder to define a dosing volume within the fluid chamber against the end of the dosing cylinder, the dosing volume being fluidically coupled to the inlet and the outlet; and a piston movable between (i) a retention position to retain fluid in the dosing volume and (ii) a discharge position to discharge fluid from the dosing volume of the fluid chamber through the outlet.

Embodiment 2. The fluid dosing mechanism of embodiment 1, wherein one of the dosing cylinder and the dial defines a helical channel, wherein the other of the dosing cylinder and the dial defines a pin engaged in the helical channel to convert relative rotation between the dial and the dosing cylinder to a translation of the dosing cylinder.

Embodiment 3. The fluid dosing mechanism of embodiment 2, wherein the dial defines a dial interior configured to receive at least a portion of the dosing cylinder, and wherein the helical channel and pin are within the dial interior.

Embodiment 4. The fluid dosing mechanism of any of embodiments 1 to 3, wherein the dial defines a plurality of exterior dial ribs, wherein the dial ribs are equally spaced about the dial, and wherein each rib of the plurality of ribs represents a respective location of the end of dosing cylinder within the fluid chamber corresponding to a respective magnitude of the dosing volume within the fluid chamber.

Embodiment 5. The fluid dosing mechanism of embodiment 4, wherein each rib of the plurality of ribs corresponds to a change of 25 mL of the dosing volume.

Embodiment 6. The fluid dosing mechanism of any of embodiments 1 to 5, wherein a maximum spacing of the end of the dosing cylinder within the fluid chamber defines a maximum dosage volume.

Embodiment 7. The fluid dosing mechanism of embodiment 6, wherein the maximum dosage volume is 300 mL.

Embodiment 8. The fluid dosing mechanism of any of embodiments 1 to 7, further comprising a valve, wherein the piston is mechanically coupled to the valve to cause the valve to move between (i) a first configuration that opens the inlet and closes the outlet to retain fluid in the dosing volume, and (ii) a second configuration that closes the inlet and opens the outlet to discharge fluid from the dosing volume.

Embodiment 9. The fluid dosing mechanism of embodiment 8, wherein the valve comprises a valve body extending between an inlet portion and an outlet portion, wherein the inlet portion is spaced from the inlet and the outlet portion is sealingly engaged with the outlet in the first configuration, and wherein the inlet portion is sealingly engaged with the inlet and the outlet portion is spaced from the outlet in the second configuration.

Embodiment 10. The fluid dosing mechanism of embodiment 9, wherein one or both of the outlet portion and the inlet portion define a respective conic surface, and wherein the valve body includes a cylindrical portion (i) extending from the respective conic surface, or (ii) between respective conic surfaces of the outlet portion and the inlet portion.

Embodiment 11. The fluid dosing mechanism of any of embodiments 9 or 10, wherein the valve further comprises an outlet seal at the outlet portion.

Embodiment 12. The fluid dosing mechanism of any of embodiments 9 to 11, wherein the valve further comprises an inlet seal at the inlet portion.

Embodiment 13. The fluid dosing mechanism of any of embodiments 11 or 12, wherein one or both of the outlet seal or the inlet seal comprises a respective o-ring.

Embodiment 14. The fluid dosing mechanism of any of embodiments 8 to 13, wherein the inlet portion of the valve further defines a stem extending through the inlet, wherein the stem is configured to engage with a fluid container in the first configuration to receive fluid from the fluid container into the dosing volume through the inlet, and wherein the stem is configured to disengage from the fluid container in the second configuration.

Embodiment 15. The fluid-dosing mechanism of embodiment 14, wherein the stem defines a plus-shaped cross-section.

Embodiment 16. The fluid dosing mechanism of any of embodiment 8 to 15, further comprising a base pivotably coupled between the piston and the valve, wherein the piston pivots the base to cause the valve to move between the first configuration and the second configuration.

Embodiment 17. The fluid dosing mechanism of embodiment 16, wherein the outlet portion further defines at least one valve pin, and wherein the base defines at least one valve channel configured to slidingly receive the at least one valve pin.

Embodiment 18. The fluid dosing mechanism of any of embodiments 16 or 17, wherein the piston further defines at least one piston pin, and wherein the base defines at least one piston channel configured to slidingly receive the at least one piston pin.

Embodiment 19. The fluid dosing mechanism of any of embodiments 1 to 18, further comprising a biasing member coupled to the piston, wherein the biasing member is biased to move the piston from the discharge position to the retention position.

Embodiment 20. The fluid dosing mechanism of embodiment 19, wherein the biasing member comprises a spring.

Embodiment 21. The fluid dosing mechanism of embodiment 20, wherein the spring is compressed when the piston is in the discharge position.

Embodiment 22. The fluid dosing mechanism of any of embodiments 1 to 21, further comprising a damper coupled to the piston, wherein the damper is configured to resist movement of the piston toward the retention position.

Embodiment 23. The fluid dosing mechanism of embodiment 22, wherein the damper is configured to resist movement of the piston toward the retention position for a predetermined period of time to substantially discharge an entirety of the contents of the dosing volume from the outlet.

Embodiment 24. The fluid dosing mechanism of any of embodiments 1 to 23, wherein the outlet is lower than the inlet relative to a direction of gravity.

Embodiment 25. The fluid dosing mechanism of any of embodiments 1 to 24, further comprising a housing securing at least one of the dosing vessel, the dosing cylinder, the dial, and the piston.

Embodiment 26. The fluid dosing mechanism of any of embodiment 25, wherein the housing comprises a top casing and a bottom casing.

Embodiment 27. The fluid dosing mechanism of any of embodiments 25 or 26, wherein the housing defines a dial window, wherein at least a portion of the dial is accessible through the dial window.

Embodiment 28. The fluid dosing mechanism of any of embodiments 25 to 27, wherein the housing defines a piston window, wherein at least a portion of the piston protrudes through the piston window.

Embodiment 29. The fluid dosing mechanism of any of embodiments 25 to 28, wherein the housing defines a stem window, wherein at least a portion of the stem of the valve protrudes through the stem window.

Embodiment 30. The fluid dosing mechanism of any of embodiments 25 to 29, wherein the housing defines a housing outlet fluidically coupled to the outlet of the fluid chamber, and a housing inlet coupled to the inlet of the fluid chamber.

Embodiment 31. fluid dosing system comprising: a system housing comprising the fluid dosing mechanism of any of embodiments 1 to 30; and a fluid container defining a container outlet fluidically coupled to the inlet of the fluid dosing mechanism.

Embodiment 32. The fluid dosing system of embodiment 31, wherein the fluid container is a first fluid container, wherein the fluid dosing system further comprises a second fluid container defining a respective container outlet fluidically coupled to the inlet of the fluid dosing mechanism.

Embodiment 33. The fluid dosing system of embodiment 32, further comprising a fluid junction comprising a first junction inlet, a second junction inlet, and a junction outlet, wherein the first junction inlet is fluidically coupled to the container outlet of the first fluid container, wherein the second junction inlet is fluidically coupled to the container outlet of the second fluid container, and wherein the junction outlet is fluidically coupled to the inlet of the fluid dosing mechanism.

Embodiment 34. The fluid dosing system of embodiment 33, wherein the fluid junction further comprises a fluid switch configured to permit flow from only one of the first fluid container and the second fluid container to the junction outlet.

Embodiment 35. The fluid dosing system of any of embodiments 31 to 34, wherein the system housing further comprises a button coupled to the piston.

Embodiment 36. The fluid dosing system of any of embodiment 31 to 35, wherein the system housing defines an access window, wherein the dial of the fluid dosing mechanism is accessible through the access window.

Embodiment 37. The fluid dosing system of any of embodiments 31 to 35, wherein the system housing further comprises a container tray configured to hold at least one fluid container.

Embodiment 38. The fluid dosing system of embodiment 37, wherein the container tray defines at least one viewing slot configured to show a fluid level in the at least one container.

Embodiment 39. The fluid dosing system of embodiment 38, wherein the system housing comprises a front panel coupled to the container tray, wherein the front panel defines at least one panel slot aligned with the at least one viewing slot.

Embodiment 40. The fluid dosing system of any of embodiments 31 to 39, wherein the system housing comprises a lid, a right side panel, a left side panel, a back panel, and a bottom panel.

Embodiment 41. The fluid dosing system of any of embodiments 31 to 40, further comprising a cleaning media tray coupled to the system housing, wherein the outlet of the fluid dosing mechanism is configured to discharge fluid toward the cleaning media tray.

Embodiment 42. The fluid dosing system of any of embodiments 31 to 40, further comprising a clean pad drawer secured to the system housing configured to hold a supply of fresh cleaning media.

Embodiment 43. The fluid dosing system of any of embodiments 31 to 40, further comprising a used pad drawer secured to the system housing configured to hold used cleaning media.

Embodiment 44. The fluid dosing system of embodiment 43, wherein the cleaning media tray is secured to a top of the used pad drawer.

Embodiment 45. A cart assembly comprising: a platform; a tower secured to the platform; a plurality of wheels coupled to the platform; and the fluid dosing system of any of claims 31 to 44 secured to the tower.

Embodiment 46. A fluid dosing mechanism as shown and described herein.

Embodiment 47. A fluid dosing system as shown and described herein.

Embodiment 48. A cart assembly as shown and described herein.

Embodiment 49. A precision dosing system comprising: a chamber; a first container disposed in the chamber, the first container comprising a fluid therein; a dosing mechanism coupled to the chamber and fluidically coupled to the first container, the dosing mechanism comprising: a first button; a first plunger coupled to the first button; a first cylinder coupled to the first plunger; and a first spring disposed around the first plunger; a clean pad container disposed below the chamber; and a tray disposed below the clean pad container, wherein the dosing mechanism is configured to dispense a predetermined amount of the fluid from the first container towards the tray when the first button is depressed.

Embodiment 50. The precision dosing system of embodiment 49, further comprising: a second container disposed in the chamber, the second container comprising a fluid therein; wherein the dosing mechanism further comprises: a second button; a second plunger coupled to the second button; a second cylinder coupled to the second plunger; and a second spring disposed around the second plunger, wherein the dosing mechanism is configured to dispense a predetermined amount of the fluid from the second container towards the tray when the second button is depressed.

Embodiment 51. The precision dosing system of embodiment 50, further comprising: a locking mechanism configured to prevent movement of only one of either the first button or the second button at a time.

Embodiment 52. The precision dosing system of embodiment 49, further comprising a front panel attached to the chamber, wherein the front panel has an aperture aligned with the first container.

Embodiment 53. The precision dosing system of embodiment 52, wherein the precision dosing system further comprises a lid attached to the front panel, wherein the first button is configured to be accessed through the lid.

Embodiment 54. The precision dosing system of embodiment 53, wherein the lid is configured to be secured onto the front panel by a lock.

Embodiment 55. The precision dosing system of embodiment 49, further comprising a dirty pad container disposed below the tray.

Embodiment 56. The precision dosing system of embodiment 55, wherein the tray forms a lid for the dirty pad container.

Embodiment 57. The precision dosing system of embodiment 49, further comprising a back panel mounted to the chamber and clean pad container, wherein the back panel has a protrusion.

Embodiment 58. The precision dosing system of any of embodiments 49-57, further comprising: a cart, wherein the cart has a panel with slots, wherein the protrusion disposed on the back panel is configured to mate with the slot.

Embodiment 59. The precision dosing system of embodiment 49, wherein the dosing mechanism further comprises: a selection mechanism configured to modify the predetermined amount of fluid that is dispensed when the first button is depressed.

Embodiment 60. The precision dosing system of embodiment 59, wherein the selection mechanism comprises: a clamshell at least partially surrounding the plunger and a plunger cylinder disposed around the plunger, wherein the clamshell comprises at least two holes; and a pin insertable through the holes, wherein the pin contacts the plunger cylinder when the first button is depressed.

Embodiment 61. A precision dosing system comprising: a chamber; a first container disposed in the chamber, the first container comprising a first fluid therein; a second container disposed in the chamber, the second container comprising a second fluid therein; a dosing mechanism coupled to the chamber and fluidically coupled to the first container, the dosing mechanism comprising: a first button; a first plunger coupled to the first button; a first cylinder coupled to the first plunger; and a first spring disposed around the first plunger; a second button; a second plunger coupled to the second button; a second cylinder coupled to the second plunger; and a second spring disposed around the second plunger; a clean pad container disposed below the chamber; and a tray disposed below the clean pad container, wherein the dosing mechanism is configured to dispense a predetermined amount of the fluid from the first container towards the tray when the first button is depressed, and wherein the dosing mechanism is configured to dispense a predetermined amount of the fluid from the second container towards the tray when the second button is depressed.

Embodiment 62. The precision dosing system of embodiment 61, further comprising a dirty pad container disposed below the tray.

Embodiment 63. The precision dosing system of embodiment 62, wherein the tray forms a lid for the dirty pad container.

Embodiment 64. The precision dosing system of embodiment 63, wherein dirty pad container is secured to the precision dosing system by a left panel and right panel, wherein the tray and dirty pad container are attached to rails on the left panel and right panel.

Embodiment 65. The precision dosing system of embodiment 62, wherein the clean pad container is secured to the precision dosing system by a left panel and a right panel, wherein the clean pad container tilts or rotates open.

Embodiment 66. A method of making a precision dosing system, comprising the steps of: providing a chamber; providing a first container disposed in the chamber, the first container comprising a first fluid therein; providing a dosing mechanism comprising; a first button; a first plunger coupled to the first button; a first cylinder coupled to the first plunger; and a first spring disposed around the first plunger; coupling a dosing mechanism to the chamber; fluidically coupling the dosing mechanism to the first container; providing a clean pad container disposed below the chamber; and providing a tray disposed below the clean pad container.

What is claimed is:

1. A fluid dosing mechanism comprising:
a dosing vessel defining a fluid chamber, the fluid chamber comprising an inlet and an outlet;
a dosing cylinder coupled to the dosing vessel and defining an end slidable within the fluid chamber;
a dial rotatably coupled to the dosing cylinder and configured to slide the dosing cylinder to define a dosing volume within the fluid chamber against the end of the dosing cylinder, the dosing volume being fluidically coupled to the inlet and the outlet; and
a piston movable between (i) a retention position to retain fluid in the dosing volume and (ii) a discharge position to discharge fluid from the dosing volume of the fluid chamber through the outlet.

2. The fluid dosing mechanism of claim 1, wherein one of the dosing cylinder and the dial defines a helical channel, wherein the other of the dosing cylinder and the dial defines a pin engaged in the helical channel to convert relative rotation between the dial and the dosing cylinder to a translation of the dosing cylinder.

3. The fluid dosing mechanism of claim 2, wherein the dial defines a dial interior configured to receive at least a portion of the dosing cylinder, and wherein the helical channel and pin are within the dial interior.

4. The fluid dosing mechanism of claim 1, wherein the dial defines a plurality of exterior dial ribs, wherein the dial ribs are equally spaced about the dial, and wherein each rib of the plurality of ribs represents a respective location of the end of dosing cylinder within the fluid chamber corresponding to a respective magnitude of the dosing volume within the fluid chamber.

5. The fluid dosing mechanism of claim 1, further comprising a valve, wherein the piston is mechanically coupled to the valve to cause the valve to move between (i) a first configuration that opens the inlet and closes the outlet to retain fluid in the dosing volume, and (ii) a second configuration that closes the inlet and opens the outlet to discharge fluid from the dosing volume.

6. The fluid dosing mechanism of claim 5, wherein the valve comprises a valve body extending between an inlet portion and an outlet portion, wherein the inlet portion is spaced from the inlet and the outlet portion is sealingly engaged with the outlet in the first configuration, and wherein the inlet portion is sealingly engaged with the inlet and the outlet portion is spaced from the outlet in the second configuration.

7. The fluid dosing mechanism of claim 5, wherein the inlet portion of the valve further defines a stem extending through the inlet, wherein the stem is configured to engage with a fluid container in the first configuration to receive fluid from the fluid container into the dosing volume through the inlet, and wherein the stem is configured to disengage from the fluid container in the second configuration.

8. The fluid dosing mechanism of claim 5, further comprising a base pivotably coupled between the piston and the valve, wherein the piston pivots the base to cause the valve to move between the first configuration and the second configuration.

9. The fluid dosing mechanism of claim 8, wherein the outlet portion further defines at least one valve pin, and wherein the base defines at least one valve channel configured to slidingly receive the at least one valve pin.

10. The fluid dosing mechanism of claim 8, wherein the piston further defines at least one piston pin, and wherein the base defines at least one piston channel configured to slidingly receive the at least one piston pin.

11. The fluid dosing mechanism of claim 1, further comprising a biasing member coupled to the piston, wherein the biasing member is biased to move the piston from the discharge position to the retention position.

12. The fluid dosing mechanism of claim 1, further comprising a damper coupled to the piston, wherein the damper is configured to resist movement of the piston toward the retention position.

13. The fluid dosing mechanism of claim 1, further comprising a housing securing at least one of the dosing vessel, the dosing cylinder, the dial, and the piston.

14. A fluid dosing system comprising:
a housing comprising a fluid dosing mechanism comprising:
a dosing vessel defining a fluid chamber, the fluid chamber comprising an inlet and an outlet;
a dosing cylinder coupled to the dosing vessel and defining an end slidable within the fluid chamber;
a dial rotatably coupled to the dosing cylinder and configured to slide the dosing cylinder to define a dosing volume within the fluid chamber against the end of the dosing cylinder, the dosing volume being fluidically coupled to the inlet and the outlet; and
a piston movable between (i) a retention position to retain fluid in the dosing volume and (ii) a discharge position to discharge fluid from the dosing volume of the fluid chamber through the outlet; and
a fluid container defining a container outlet fluidically coupled to the inlet of the fluid dosing mechanism.

15. The fluid dosing system of claim 14, wherein the fluid container is a first fluid container, wherein the fluid dosing system further comprises a second fluid container defining a respective container outlet fluidically coupled to the inlet of the fluid dosing mechanism.

16. The fluid dosing system of claim 15, further comprising a fluid junction comprising a first junction inlet, a second junction inlet, and a junction outlet, wherein the first junction inlet is fluidically coupled to the container outlet of the first fluid container, wherein the second junction inlet is fluidically coupled to the container outlet of the second fluid container, and wherein the junction outlet is fluidically coupled to the inlet of the fluid dosing mechanism.

17. The fluid dosing system of claim 16, wherein the fluid junction further comprises a fluid switch configured to permit flow from only one of the first fluid container and the second fluid container to the junction outlet.

18. The fluid dosing system of claim 14, wherein the system housing further comprises a container tray configured to hold at least one fluid container.

19. The fluid dosing system of claim 14, wherein the system housing comprises a lid, a right side panel, a left side panel, a back panel, and a bottom panel.

20. A cart assembly comprising:
a platform;
a tower secured to the platform;
a plurality of wheels coupled to the platform; and
a fluid dosing system comprising:
a housing comprising a fluid dosing mechanism comprising:
a dosing vessel defining a fluid chamber, the fluid chamber comprising an inlet and an outlet;
a dosing cylinder coupled to the dosing vessel and defining an end slidable within the fluid chamber;
a dial rotatably coupled to the dosing cylinder and configured to slide the dosing cylinder to define a dosing volume within the fluid chamber against the end of the dosing cylinder, the dosing volume being fluidically coupled to the inlet and the outlet; and
a piston movable between (i) a retention position to retain fluid in the dosing volume and (ii) a discharge position to discharge fluid from the dosing volume of the fluid chamber through the outlet; and
a fluid container defining a container outlet fluidically coupled to the inlet of the fluid dosing mechanism.
